(19) United States
(12) Patent Application Publication
(10) Pub. No.: US 2007/0185787 A1
(43) Pub. Date: Aug. 9, 2007

(54) Method for Automatically Processing Warranty Registrations

(76) Inventors: Jo L. Shernaman, Columbia, MO (US); Allen Shernaman, Columbia, MO (US); Ryan Shernaman, Columbia, MO (US); Briana Shernaman, Columbia, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/460,945

(22) Filed: Jul. 28, 2006

Related U.S. Application Data
(60) Provisional application No. 60/703,397, filed on Jul. 28, 2005.

(51) Int. Cl. G06Q 10/00

(52) U.S. Cl. 705/28

(57) ABSTRACT

The present invention is directed to a method for automatically registering a warranty for a vehicle by entering into a computer information identifying the vehicle, entering into a computer information related to the purchaser of the vehicle, and transmitting the information to a vehicle manufacturer in such as way as to electronically register the vehicle warranty.

### CROSS-REFERENCE TO RELATED APPLICATIONS

This application claims priority of U.S. Provisional Application No. 60/703,397, filed Jul. 28, 2005.

### STATEMENT REGARDING FEDERALLY SPONSORED RESEARCH OR DEVELOPMENT

Not Applicable.

### INCORPORATION BY REFERENCE OF MATERIAL SUBMITTED AS A TEXT FILE ATTACHED TO THE ELECTRONIC FILING

A computer program listing appendix is attached hereto as a text file entitled “ShernamanSourceCode.txt,” and is hereby incorporated into this document by reference.

### BACKGROUND OF THE INVENTION

The present invention is directed generally to a method of automatic warranty registration and, more specifically, to a method of automatically registering warranties for motorcycles.

In order to secure the protections provided by a warranty covering a product such as a motorcycle, it is mandatory for a dealer to file a warranty registration with the motorcycle manufacturer. Should a dealer who sells a motorcycle fail to file the warranty registration in a timely manner, certain rebates, discounts, holdbacks, and the like offered by the motorcycle manufacturer will not apply to that sale. Failure to file a warranty registration with the motorcycle manufacturer could also result in the consumer having payment for warranty repairs refused by the motorcycle manufacturer.

Warranty registrations are traditionally filed manually, via data entry. This presents a number of potential problems in the warranty registration process. Registrations may be lost, resulting in a situation in which the customer believes the warranty has been properly registered when, in fact, it has not. Even if the warranty is properly registered, if the registration takes place more than 15 days after the date of sale, some manufacturers penalize the selling dealer. Further, with manual warranty registration, the consumer may inadvertently provide incorrect information, such as misprinted information identifying the motorcycle for which the warranty is being registered, resulting once again in a failure to register the warranty for a specific motorcycle. Under a traditional warranty registration scenario, the consumer may not find out about the mistake for some time, if at all, and protection may be lost.

Even if completely successful, the process of entering registrations manually by data entry is an extremely time consuming process. A dealer is required to provide this service for a customer, but all of the potential pitfalls described above still apply and, further, the dealer may have to assume responsibility for any errors in the registration process. All rebates, holdbacks, discounts, and the like that were applicable to this sale are revoked if the warranty registration is not entered correctly within a clearly defined time frame.

What is needed, then, is an automated process for registration of motorcycle warranties wherein immediate confirmation of registration or notification of errors is provided to the person seeking to register the warranty.

### BRIEF SUMMARY OF THE INVENTION

The present invention is directed to a method for automatically registering a warranty for a vehicle by entering into a computer information identifying the vehicle, entering into a computer information related to the purchaser of the vehicle, and transmitting the information to a vehicle manufacturer in such as way as to electronically register the vehicle warranty.

In another aspect of the present method, the step of recording in an inventory database the fact that a warranty for a particular vehicle has been registered is also included.

In still another aspect of the present method, the step of alerting the user to the success or failure of the electronic registration process is also included.

In another aspect of the present method, the step of transmitting to a manufacturer information required by that manufacturer to successfully complete a vehicle registration is also provided.

In another aspect of the present invention, the step of providing to a manufacturer information regarding the gender of a customer is provided.

In another aspect of the present invention, the step of providing to a manufacturer information regarding the identity of a dealer involved in a sale of a vehicle is provided.

another aspect of the present invention, the step of providing a Honda® Code to a manufacturer when registering a Honda® motorcycle is provided.

### BRIEF DESCRIPTION OF THE DRAWINGS

Not Applicable.

### DETAILED DESCRIPTION OF THE INVENTION

The present invention provides a method for automatic warranty registration. Briefly, the method includes receiving user input related to the sale of a vehicle such as a motorcycle and using that information, in combination with information about the purchaser to effect electronic warranty registration for the vehicle. The user input is generally provided by a dealer. The method further includes the step of retrieving information about the vehicle sold, such as the VIN number or other identifying information. The information about the vehicle is generally retrieved electronically from a database having the information stored therein. Finally, the method includes the step of delivering electronically the vehicle information and customer information along with an electronic warranty registration such that the warranty is registered in a manner acceptable to the vehicle manufacturer. The warranty information, and accompanying information, is generally provided electronically directly to the manufacturer.

The information about the purchaser may be provided by the dealer in any suitable manner such as, for example, by entering the information manually or by automated retrieval of the information from a computer database or file, such as a sales information database. As used herein, the term “entering,” in reference to entering purchaser, vehicle, or other information into a computer system may refer to manual entry by an individual, automated retrieval of the information from a computer database (and subsequent ‘entry’ into the computer system), or any other method of entering data.

In another aspect of the present invention, the present method includes the step of retrieving a Honda® Code for a specific vehicle that is required in order to successfully process a Honda® warranty registration. The Honda® Code may be retrieved from a conventional computer database or from an online database or other web-based resource. This aspect of the present method includes the step of transmitting the correct Honda® Code to the manufacturer when registering Honda® motorcycles. Any suitable method of determining whether the purchaser is male or female may be used, including, for example, cross-referencing the name of the purchaser with a database of names and associated genders.

In another aspect of the present method, a computer program in accordance with the present invention electronically accesses a table for purposes of determining whether a given purchaser is more likely to be male or female. This data may be supplied to the manufacturer along with the warranty registration information, and may also be retained by the dealer as purchaser demographic information.

It is recognized that the various aspects of the present invention may come into play depending on the manufacturer with which a warranty registration is being performed. For example, when registering a Yamaha® vehicle, the present method includes the step of automatically interfacing with the Yamaha® warranty registration site, providing the correct dealership information to the Yamaha® warranty registration site (including providing information for the correct dealership when there are multiple relevant dealerships), and registering each sale without the need for an operator to connect directly with Yamaha®'s warranty registration interface.

In addition to the above, another aspect of the present method includes alerting the user to errors in the registration process such as, for example, when a given vehicle has already been registered, if mandatory information (such as the Honda® Code) is not correctly provided, or if the registration fails for any other reason. This information may come from the manufacturer, for instance when the manufacturer already has a warranty registration corresponding to a particular VIN number or other vehicle identifying information, or may come from the dealer's own database in another aspect of the present method wherein the method includes the step of updating an inventory database to reflect which vehicles have already been registered. Further, in one aspect of the present invention, a computer program in accordance with the present invention automatically marks each record in a database with a date of registration for the particular vehicle represented by that record. This provides the dealer with readily accessible information regarding the registration status of the vehicle in question.

In addition, in another aspect of the present invention, the method includes the capability for handling multiple dealerships with multiple identities, and provides safeguards such that sales made by one dealership cannot be erroneously entered into a manufacturer database as having been made by another dealership. This may be accomplished, for example, by providing a unique dealership identifier with the registration, the dealer identifier being automatically generated by the dealer computer system during the warranty registration process and not subject to being changed by an employee of the dealer.

It is contemplated that the present invention can be adapted to any of a number of manufacturer requirements, the present invention being focused on the concept of gathering purchaser and vehicle information and transferring it electronically to the computer system of a manufacturer, along with the manufacturer's individually required information, to achieve a successful, automated warrant registration.

It will be obvious to those of skill in the art upon reading this disclosure that many variations of the present invention are possible without departing from the spirit or scope of the invention described herein. The number and kind of modifications that may be made to the present device are varied and large, and it is contemplated that such modifications are within the scope of the present invention. The specific embodiments described herein are given by way of example only, and the present invention is limited only by the appended claims.

1. A method for automatically registering a warranty for a vehicle comprising:
entering into a computer system information identifying a vehicle for which a warranty is to be registered;
entering into said computer system information relating to a customer purchasing said vehicle; and
transmitting said information identifying said vehicle and said information relating to said customer via said computer system to a manufacturer of said vehicle such that a warranty for said vehicle is registered with said manufacturer.

2. A method according to claim 1 further comprising the step of recording in an inventory database of a dealer that a warranty registration has been performed with respect to said vehicle.

3. A method according to claim 1 wherein said step of entering into said computer system information identifying said vehicle is automated and comprises retrieving said information identifying said vehicle from a computer database.

4. A method according to claim 1 wherein said step of entering into said computer system information relating to said customer is automated and comprises retrieving said information relating to said customer from a computer database.

5. The method according to 3 wherein said step of entering into said computer system information relating to said customer is automated and comprises retrieving said information relating to said customer from a computer database.

6. The method according to claim 1 further comprising the step of transmitting to said manufacturer information required by said manufacturer to successfully complete the registration process.

7. The method according to claim 1 further comprising the step of transmitting to said manufacturer information identifying the dealer completing the sale of said vehicle such that the identity of said dealer is accurately recorded with said manufacturer.

8. The method according to claim 1 wherein said vehicle is a motorcycle.

9. A method for automatically registering a warranty for a vehicle comprising:
entering into a computer system information identifying a vehicle for which a warranty is to be registered;
entering into said computer system information relating to a customer purchasing said vehicle;
transmitting said information identifying said vehicle and said information relating to said customer via said computer system to a manufacturer of said vehicle in the form of an electronic warranty registration; and
alternatively performing one of the following steps:
a) if said electronic warranty registration is successful, alerting said user via said computer system that said electronic warranty registration is successful; or
b) if said electronic warranty registration is not successful, alerting said user via said computer system of the failure of said electronic warranty registration.

10. The method of claim 9 wherein said vehicle is a motorcycle.

11. The method of claim 9 further comprising the step of determining automatically the gender of said customer and transmitting to said manufacturer the gender of said customer.

12. The method according to claim 8 further comprising the step of transmitting to said manufacturer information required by said manufacturer to successfully complete the registration process.

13. The method according to claim 8 further comprising the step of transmitting to said manufacturer information identifying the dealer completing the sale of said vehicle such that the identity of said dealer is accurately recorded with said manufacturer.

14. A method for automatically registering a warranty for a Honda® motorcycle comprising:
accessing with a computer system information identifying a motorcycle for which a warranty is to be registered;
obtaining electronically a Honda® Code for said motorcycle;
accessing with a computer system information relating to a customer purchasing said vehicle;
transmitting said information identifying said vehicle, said information relating to said customer, and said Honda® Code via said computer system to a manufacturer of said vehicle in the form of an electronic warranty registration.

15. The method of claim 13 further comprising the step of determining automatically the gender of said customer and transmitting to said manufacturer the gender of said customer.
